(19) United States
(12) Patent Application Publication
(10) Pub. No.: US 2015/0324482 A1
(43) Pub. Date: Nov. 12, 2015

(54) NETWORK GRAPH GENERATION METHOD AND DECISION-MAKING ASSISTANCE SYSTEM

(71) Applicant: Hitachi, Ltd., Chiyoda-ku, Tokyo (JP)

(72) Inventors: TAKESHI KATO, Tokyo (JP); Koji FUKUDA, Tokyo (JP); Masaki HAMAMOTO, Tokyo (JP); Yasuyuki KUDO, Tokyo (JP); Hiroyuki MIZUNO, Tokyo (JP)

(73) Assignee: Hitachi, Ltd, Chiyoda-ku, Tokyo (JP)

(21) Appl. No.: 14/646,119

(22) PCT Filed: Nov. 29, 2012
(86) PCT No.: PCT/JP2012/080945

§ 371 Date: May 20, 2015

(51) Int. Cl. G06F 17/30; G06F 3/0481

(52) U.S. Cl. CPC G06F 17/30958; G06F 3/0481

(57) ABSTRACT

A decision-making support system which is a client-server system comprising: multiple servers; a client having a display; a network; and a database. On the basis of data acquisition conditions supplied via the client the multiple servers acquire from the data base on multiple distributed processing platforms, a first data group spanning from the past to the present, and generate a first network graph for the time from the past to the present. The multiple servers also execute multiple simulations based on the first data group, on the basis of provided simulation conditions, and generate second and third network graphs for a time not included in the first data group or for the future. The client receives the results of the generation of these network graphs and displays on the display the first through third network graphs spanning from the past to the present, and to the future, thereby providing the user with a scenario map.

### TECHNICAL FIELD

The present invention relates to a method or generating a network graph constituted by vertices and edges or nodes and links, as well as a decision-making support system, and specifically to a method of creating a network graph or a scenario map using big data suitable for the decision-making support system.

### BACKGROUND ART

With a rapid growth of telecommunications such as the Internet, social media, Sensor Networks, mobile phones, and the like, there is an increasingly active movement of using the big data generated therefrom for decision-making by means of statistical analysis and data mining.

For example, in a chance discovery method, an event series based on a certain context is referred to as a scenario, a significant event or situation triggering the scenario to transit is regarded as a chance, and decision-making is considered as selection of a scenario at the chance. As a way of presenting a scenario, a scenario map is used such as a network graph and a potential map that visualizes a frequency and a co-occurrence degree of the event, and KeyGraph and KeyBird are known as a tool thereof.

Nonpatent Literature 1 discloses a scenario map that has occurred from the past to the present using “Polaris” as an integrated data miner for chance discovery. Moreover, Nonpatent Literature 2 discloses future prediction based on a history analysis of a scenario as a chance discovery method, and Nonpatent Literature 3 discloses visualization of a hidden event by a data crystallization method.

Patent Literature 1 discloses a subject and a configuration of communication by visualising communication data of participants of a computer-based collaboration with a network graph using the chance discovery method, thereby supporting the collaboration.

Patent Literature 2 proposes, in knowledge extraction from a text database, clarifying relations and differences among associated data and extracting useful knowledge not merely by presenting associated data bat by extracting associative networks in a predetermined co-occurrence relation from the database and integrating a synonym.

Patent literature 3 proposes eliminating ambiguity in parsing by learning a hierarchical relation of concepts between words and a co-occurrence degree of the words and the concepts as a network graph structure that is a concept hierarchy tree, thereby optimizing .Language processing in a language processing system such as a machine translation.

### PRIOR ART LITERATURE

### Patent Literature

Patent Literature 1; U.S. Patent Publication no. 2005/0276479

Patent Literature 2: Japanese Patent Laid-open No. H06-168129

Patent Literature 3: Japanese Patent Laid-open No. H03-305608

### Nonpatent Literature

Nonpatent Literature 1: Okazaki, N. and Ohsawa, Y., “Polaris: An Integrated Data Miner for Chance Discovery”, in Workshop of Chance Discovery and Its Management fin conjunction with International Human Computer interaction Conference (HCI2003)), pp. 27-30, Crete, Greece (2003)

Nonpatent Literature 2: Ohsawa, Y., “KeyGraph as Risk Explorer from Earthquake Sequence”, Journal of Contingencies and Crisis Management (Blackwell) Vol. 10, No. 3, pp. 119-1.28 (2002)

Nonpatent Literature 3: Ohsawa, Y., “Data Crystallization: A Project Beyond Chance Discovery for Discovering Unobservable Events”, IEEE international Conference on Granular Computing, Beijing (2005), Vol. 1, pp. 51-56

### SUMMARY OF THE INVENTION

### Technical Problem to be Solved by the Invention

According to Simon's decision-making theory, unprogrammed decision-making regarding a complex systems such as a social system or an economic system is restricted by a bounded rationality of information acquiring capability and information processing capability and cannot correctly predict a future. Thus, there is a need for executing the decision-making based on the satisfaction principle from among alternatives that satisfy a certain target level.

According to Luhmann's social systems theory, the social system is an autopoiesis system based on a chain of communication consisting of information, message, and understanding, and the chance discovery is, according to Ohsawa's decision-making technique, a double helix process consisting of concern, understanding, proposal, and action based on an interaction between a computer and a human that constitutes the society.

Combining both, the decision-making support system can be regarded as a double helix autopoiesis system based on coordination between a human and a computer, and the computer needs to provide a service that satisfies the satisfaction principle within a bounded rationality to an uncertain future while adapting to change of humans and environment.

With an upcoming decision-making support system, it will be important to comprehensively present various scenarios that may not be recognized by a human with limited information, capability, and time for the uncertain future within a bounded rationality.

However, the conventional scenario map described in the above prior art documents can merely present an event from the past to the present and analyze and metamorphose the scenario therefrom.

For example, Nonpatent Literature 2 allows for estimating an event that will occur in the future by comparing histories of the scenario maps from the past to the present, Patent Literature 1 allows for visualizing the network graph of communication. Patent Literature 2 allows for extracting an associated co-occurrence network, and Patent Literature 3 allows for learning the concept hierarchy network. However, none of the above presents the future scenario itself.

It is a subject of the present invention to provide a network graph generation method of creating various scenarios that may occur in the future, and a decision-making support system supporting decision-making by presenting various network graphs that satisfy the satisfaction, principle for the uncertain future.

### Means of Solving the Problems

A typical example of the present invention is as follows. A network: graph generation method using a decision-making support system, wherein the decision-making support system includes a condition input reception function, a data acquisition function, a graph generation function, a simulation function, and a database; the method comprising: receives an input of a network graph generation condition; acquires data about a certain context based on the generation condition input thereto and accumulates the data in the database; generates a first network graph at a first time from the past to the present corresponding to the generation condition based on the acquired data about the certain context; generates a second network graph at a second time from the past to the present that differs from the first time corresponding to the generation condition based on the acquired data about the certain context; and generates a third network graph at a virtual third time based on the first network graph and the second network graph by simulation corresponding to the generation condition.

### Effects of the Invention

The present invention provides an effect of supporting the user to make a satisfactory decision for the uncertain future by creating various network graphs at new times, namely scenario maps, and presenting them to the user that is a decision-making entity.

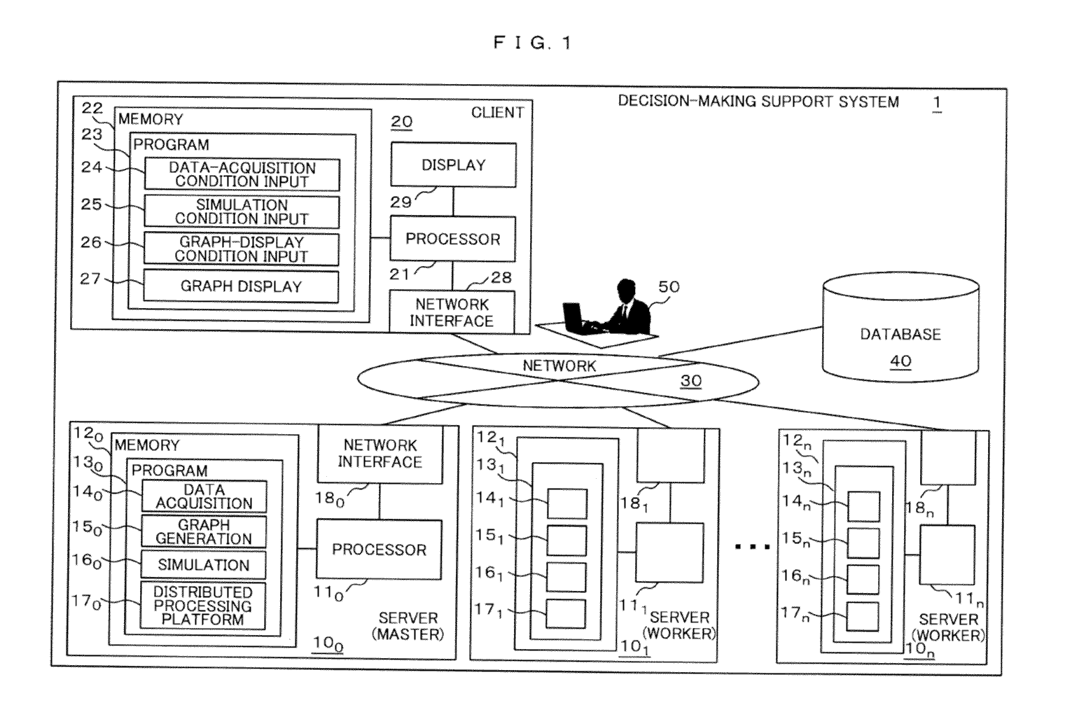

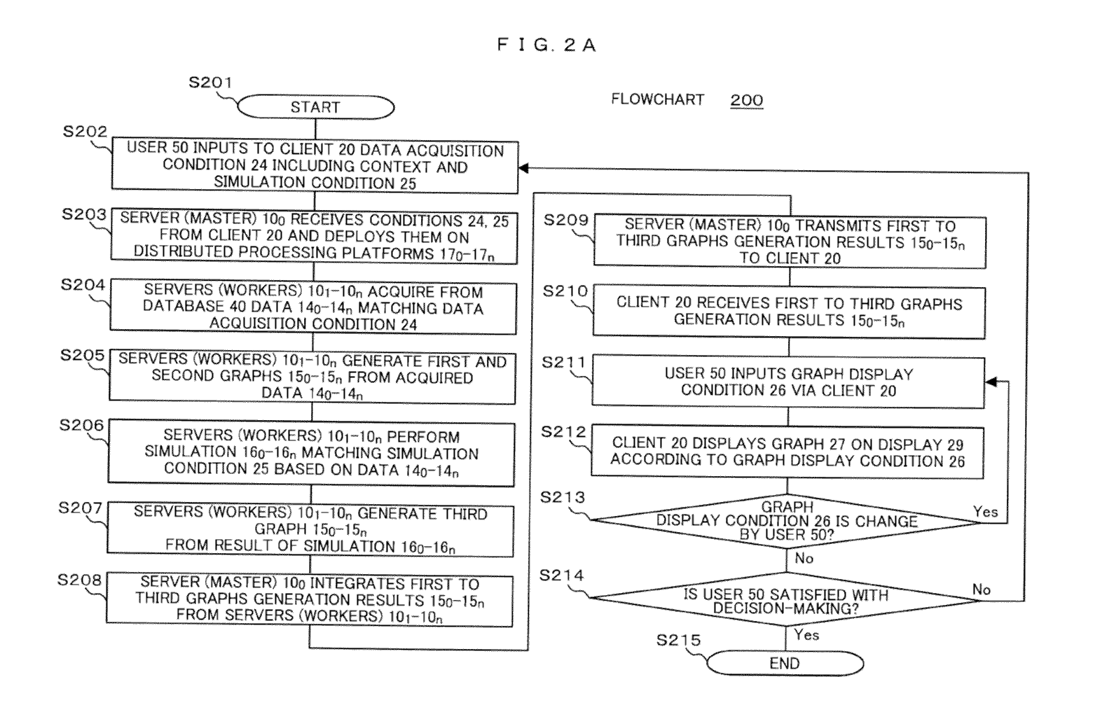

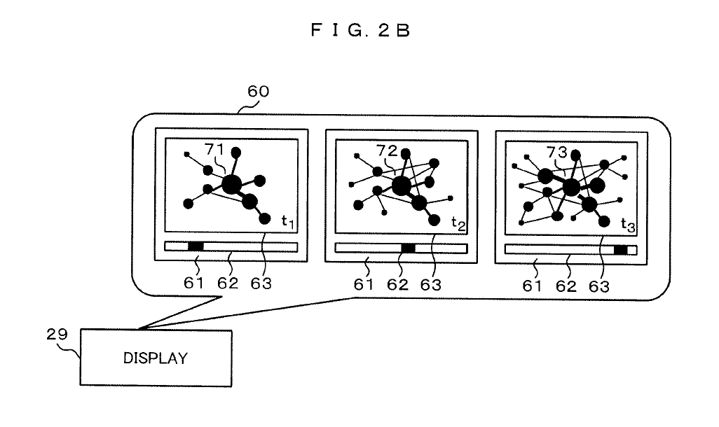

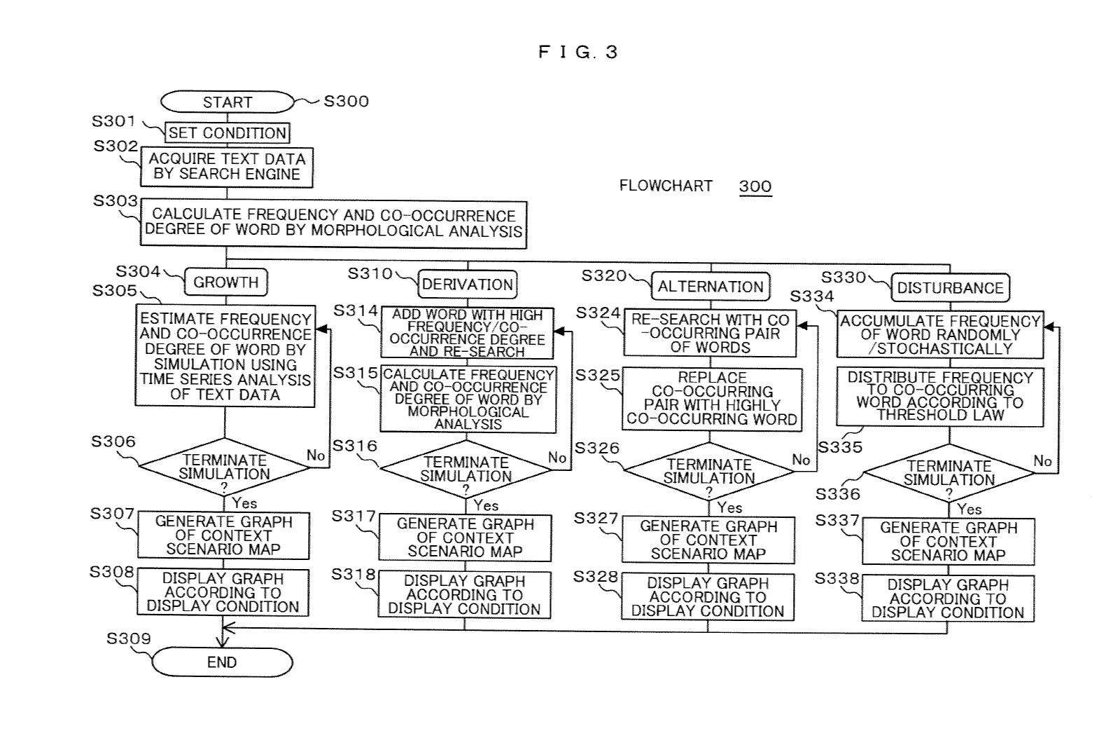

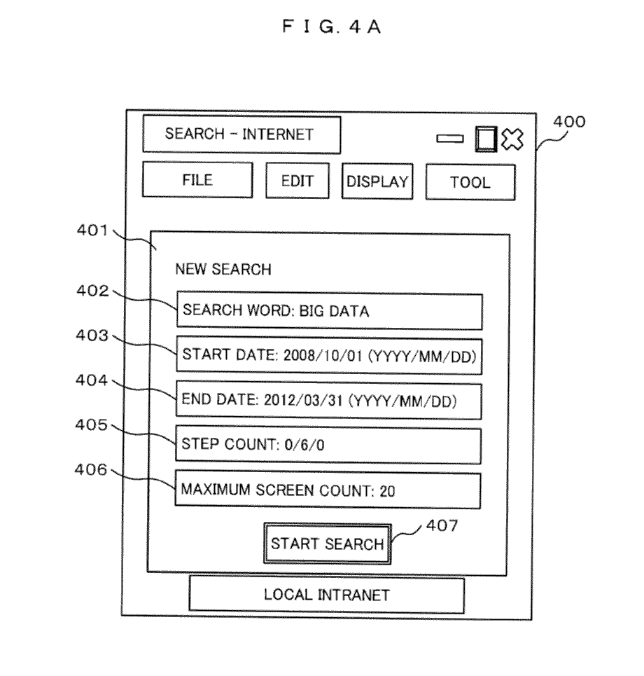

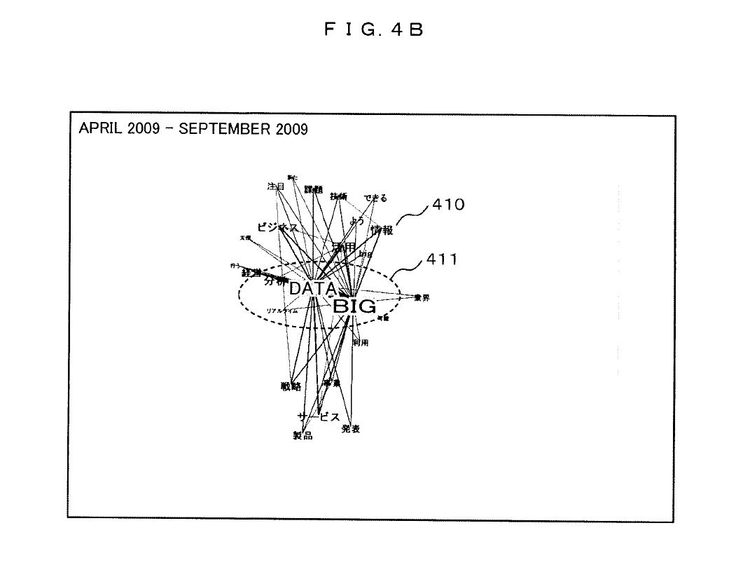

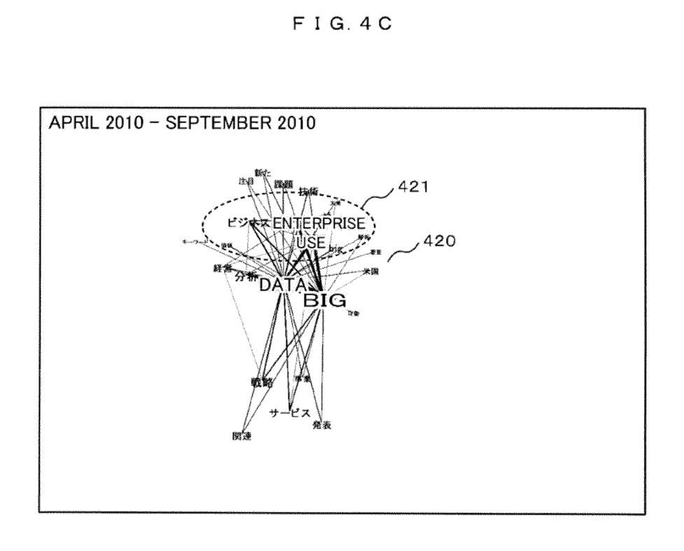

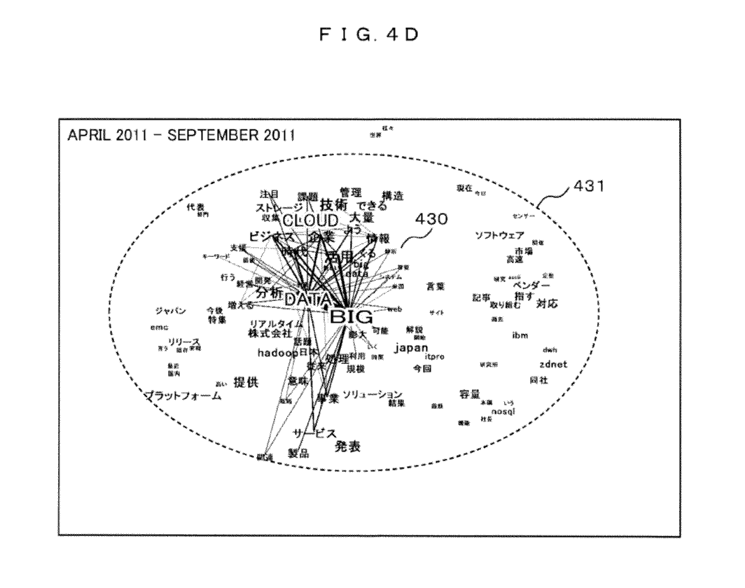

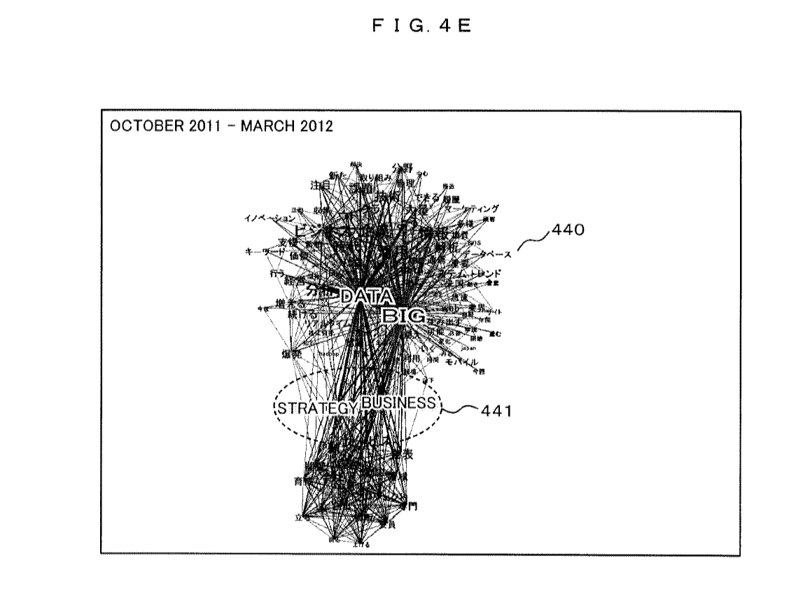

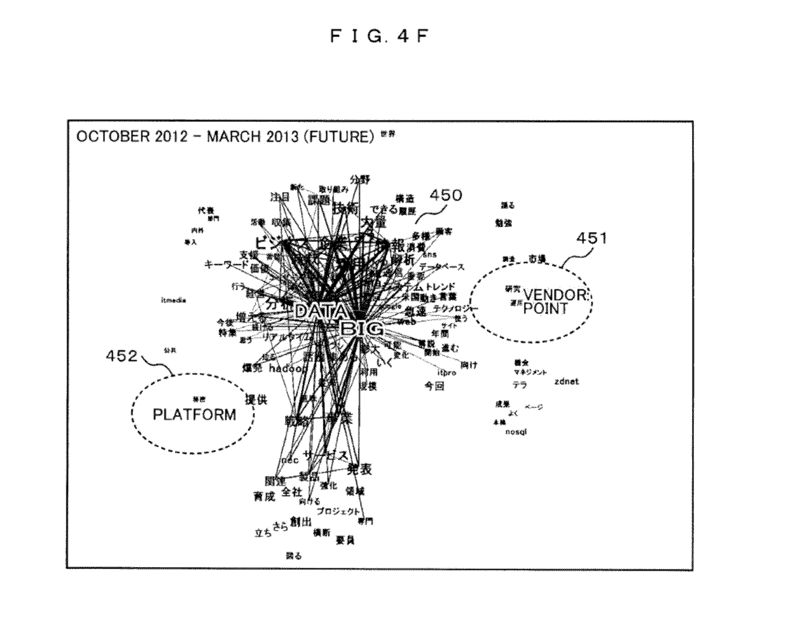

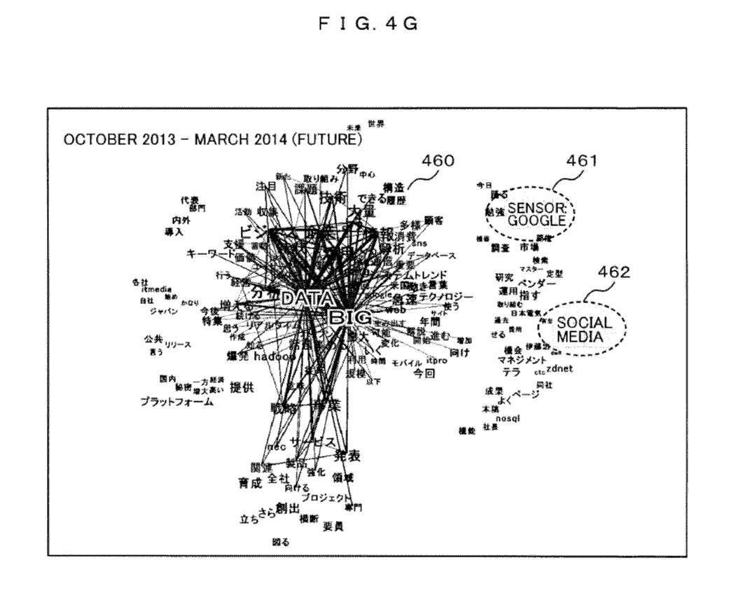

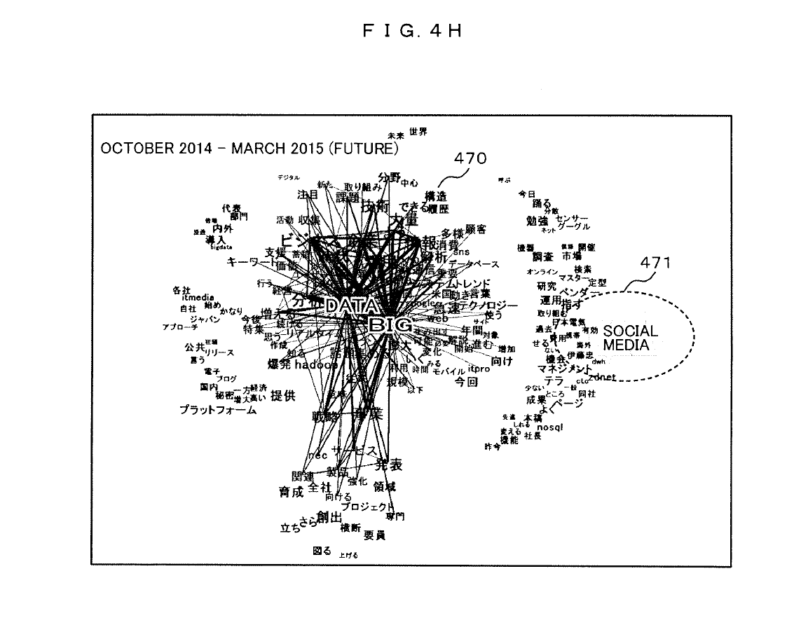

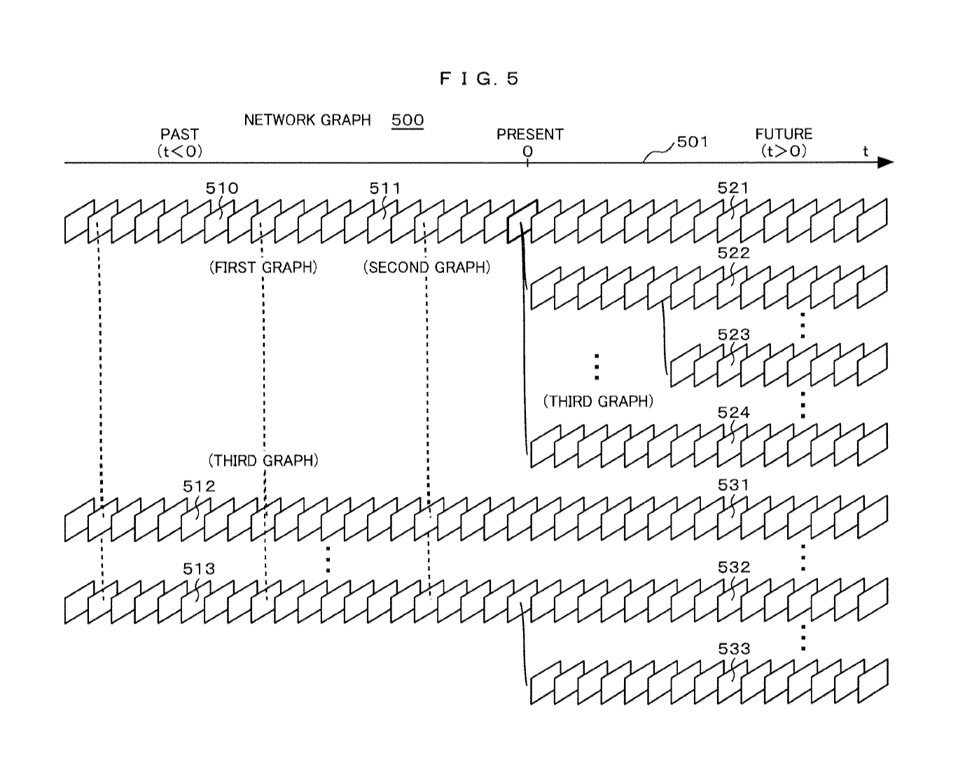

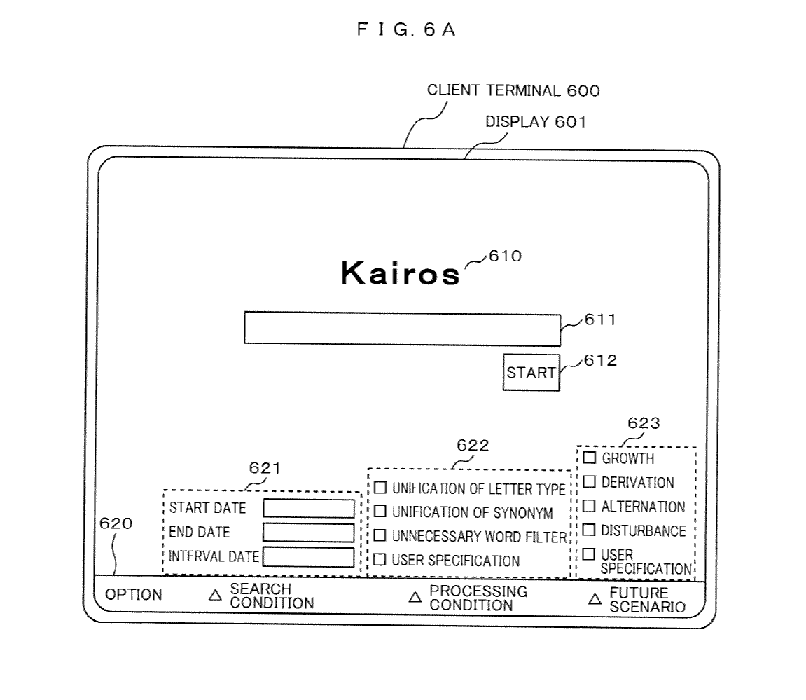

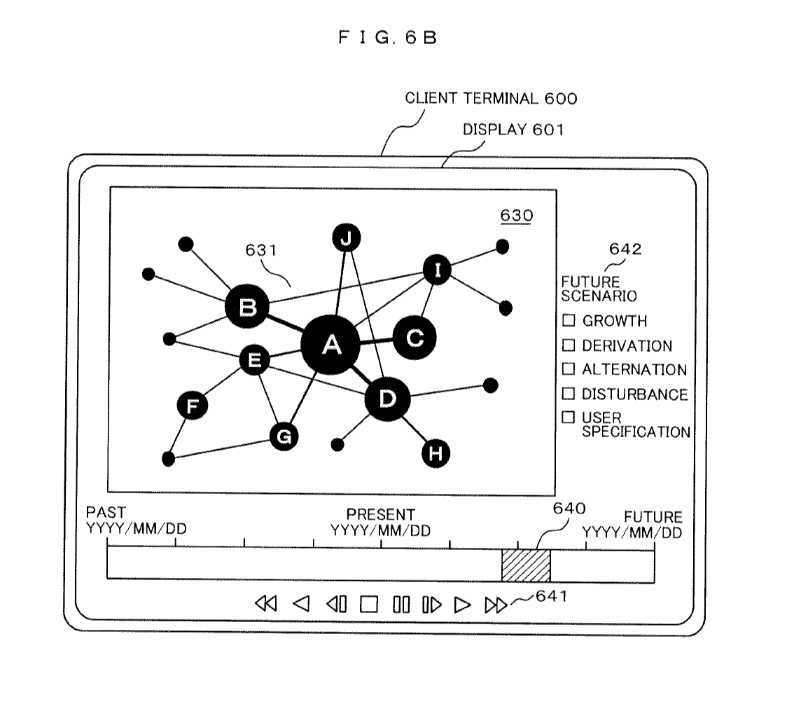

### BRIEF DESCRIPTION OF THE DRAWINGS

[FIG. 1] A block diagram, illustrating a decision-making support system to which a network graph generation method according to the first embodiment of the present invention is applied.

[FIG. 2A] A flowchart illustrating a network graph generation method according to the first embodiment.

[FIG. 2B] A diagram showing an example of a network graph display according to the first embodiment.

[FIG. 3] A flowchart illustrating a network graph generation method according to a second embodiment of the present invention.

[FIG. 4A] A diagram showing a screen of a display for a new search according to the second embodiment.

[FIG. 4B] A diagram showing a generation process of the first network, graph.

[FIG. 4C] A diagram showing the generation process of the first network graph.

[FIG. 4D] A diagram showing a generation process of the second network graph.

[FIG. 4E] A diagram showing the generation process of the second network graph.

[FIG. 4F] A diagram showing a generation process of the third network graph (growth).

[FIG. 4G] A diagram showing the generation process of the third network graph (growth),

[FIG. 4H] A diagram showing the generation process of the third network graph (growth).

[FIG. 5] A time-series transition diagram of a network graph according to the third embodiment of the present invention.

[FIG. 6A] A display screen shot for explaining a network graph generation method according to a fourth embodiment of the present invention.

[FIG. 6B] A display screen shot for explaining the network graph generation method according to the fourth embodiment.

### MODE TOR CARRYING OUT THE INVENTION

The present invention provides a decision-making support service that satisfies the satisfaction principle for the uncertain future to achieve an autopoietic decision-making support system in cooperation between a human and a computer by using big data and presenting various scenarios that may occur in the future as a bundle of possibilities to a human that is a decision-making entity.

According to a typical embodiment of the present invention, a decision-making support system includes a means for generating first and second network graphs constituted by vertices and edges or nodes and links at several time points from the past, to the present, generating a third network graph of another virtual time based thereon, and presenting them as scenario snaps. More preferably, it sets the virtual time in the future ahead of the present and presents a future scenario map.

The means for presenting the first and second network graphs from the past to the present as well as the newly generated third network graph for the future, graphically displays various network graphs according to time specification made by a time slider or selection of the generation method.

The means for generating the network graph for the future generates various third network graphs for the future by, for example, developing the first and second network graphs into the future based on the change (difference) from the past to the present, or by growing, deriving, alternating, or disturbing them.

With a client-server system for generating the network graph, a client inputs a data acquisition condition and a simulation condition, a server generates the first and second network graphs from the past to the present based on the data and newly generates the third network graph of the virtual time using a simulation, and also displays the first to third network graphs on the client.

Hereinafter, embodiments of the network graph generation method according to the present invention will be described in detail with reference to drawings.

### First Embodiment

FIG. 1 is a block diagram of a decision-making support system to which a network graph generation method according to a first embodiment of the present invention is applied. The decision-making support system 1 is a client-server system comprising multiple servers 10₀-10ₙ, a client 20, a network 30, and a database 40.

The multiple servers 10₀-10ₙ constitute a distributed processing system using the server 10₀ as a master and the servers 10₁-10ₙ as workers, and include multiple processors 11₀-11ₙ, multiple memories 12₀-12ₙ, and multiple network interfaces 18₀-18ₙ, respectively. The memories 12₀-12ₙ are equipped with multiple programs 13₀-13ₙ for having a computer (processor) implement various functions respectively. That is, they include data acquisition programs 14₀-14n for having the computer implement the data acquisition function, multiple network graph generation programs 15₀-15n for implementing the graph generation function, and multiple simulation programs 16₀-16ₙ for implementing the simulation function, on multiple distributed processing platforms 17₀-17ₙ, respectively.

It should be noted that various types of simulation programs are installed on each of the multiple servers 10₀-10ₙ to enable multiple types of simulations based on different prediction methods and presentation of various network graphs of the virtual third time.

The client 20 includes a processor 21, a memory 22, a network interface 28, and a display 29. The memory 22 is equipped with multiple programs 23 for having the computer (processor) implements various functions. That is, it includes a data acquisition condition input unit 24 and a simulation condition input unit 25 for having the computer implement the generation condition input, reception function, and a network-graph display condition input unit 26 and a network-graph display unit 27 for having the computer implement the display condition input reception function, as an interface of a user terminal 50.

The client 20 can make the user terminal 50 and the decision-making support system 1 interactively cooperate with each other by having the user terminal 50 input the data acquisition condition, input the simulation condition or select the simulation method, and input the network-graph display condition. The network-graph display unit 27 displays the generation result of the network graph on the screen of the display 29.

The network 30 connects the multiple servers 10₀-10ₙ to the multiple network interfaces 18₀-18ₙ, 28 of the client 20 to constitute the client-server system. The database 40 stores therein the data from the past to the present and supplies the data required for the decision-making to the multiple servers 10₀-10ₙ via the network 30.

FIG. 2A is a flowchart illustrating the network graph generation method according to the first embodiment of the present invention. The flowchart 200 starts from Step 201, and a user first inputs a condition for the network graph generation to the client 20 via the terminal 50 at Step 202. The condition for generation of the network graph includes the data acquisition condition 24 such as the “context,” and the simulation condition 25 for executing multiple types of simulations in an alternative or combined manner. The user can also input the display condition of the network graph to the client 20 via the terminal 50 as needed. The client 20 receives the inputs of the generation condition and the display condition of the network graph and transmits them to the server (master) 10₀ via the network.

At Step 203, the server (master) 10₀ receives the data acquisition condition 21 and the multiple simulation conditions 25 from the client 20, and develops them into the distributed processing platforms 17₀-17n of the multiple servers 10₀-10ₙ.

At Step 204, the multiple servers (workers) 10₁-10ₙ execute data acquisitions 14₀-14ₙ to match the data acquisition condition 24 from the database 40. The database 40 includes various data such as a text, an image, a video, and sensor data depending on an object of the decision-making, and those data are systematized in the form of the “context” or “content” contained therein. As a data acquisition method, it is also possible to make use of a web search engine and social media. For example, the multiple servers (workers) can access an external web search engine via the network and collets the data matching the data acquisition condition. In this manner, the data about a certain context from the past to the present can be acquired based on the input acquisition condition 24.

At Step 205, the multiple servers (workers; 10₁-10ₙ execute the network graph generation at a first time t₁ in the past based on the acquired data 14₀-14ₙ (first graph generation) and the network graph generation at a second time t₂ (present or near present) from the past to the present (second graph generation; 15₀-15ₙ.

The network graph as the first time t₁ in the past indicates a real history or the fact actually occurred at the first time t₁ in the past generated as a scenario map or a network graph from the past to the present. Moreover, the network graph at the second time t₂ can also be created, for example, by a technique of generating a scenario map based on the fact and the history occurred from the past to the second time t₂.

As a means for generating the network graph at the first time t₁ and the second time t₂, the techniques described in Nonpatent Literature 1 and Nonpatent Literature 2 may also be used.

As described in detail in the following embodiment, the first time t₁ and the second time t₂ respectively include one or multiple time points such as a first time period (t₁₁-t₁ₙ and a second time period (t₂₁-t₂ₙ), respectively. By using these multiple data pieces of the first time t₁ and the second time t₂, the accuracy of the simulation can be improved and various network graphs can be generated that satisfy the satisfaction principle at the virtual third time or in the third time period (t₃₁-t₃ₙ).

At Step 206, the servers (workers) 10₁-10ₙ execute the simulations 16₀-16ₙ that match the simulation condition 25 based on the acquired data 14₀-14ₙ, and at Step 207, the servers (workers) 10₁-10ₙ execute the network graph generation (third graph generation) 15₀-15ₙ at the virtual third time t₃ (optional past or future time) not included in the acquired data 14₀-14ₙ from the simulation execution results 16₀-16ₙ.

As multiple types of simulation methods based on different prediction methods for generating the network graph at the time t₃ in she future (or optional past), for example, a method of performing a statistical prediction using an autoregression model or a moving-average model based on a time-series change in the frequency and the co-occurrence degree in the data from the past to the present (historical drift, growth), a method of adding analogical data and associated data to the initial data acquisition condition (phylogeny, derivation), a method of alternating a data co-occurring pair with data having a higher co-occurrence degree (genetic mutation, heterogeness), and a method of causing a critical state of the data using a sandpile model and an earthquake model in the track of complex system approaches to the natural world or societies (selection, disturbance) are useful. By combining multiple types of simulations based on these different prediction methods, various possibilities for the future can be presented.

At Step 208, the server (master) 10₀ integrates the network graph generation results 15₀-15n at the Step 205 and Step 207 from the servers (workers) 10₁-10ₙ, and at Step 209, the server (master) 10₀ transmits the network graph generation results (first to third graph generation results; 15₀-15ₙ to the client 20.

At Step 210, the client 20 receives the network graph generation results 15₀-15ₙ, and in response to sensing it, at Step 211, the user inputs the network-graph display condition 26 from the client 20 through the terminal 50.

At Step 212, the client 20 executes the network graph display 27 on the display 23 according to the display condition 26, and presents the network graph generation results (first to third graph generation results) 15₀-15n at the first time t₁ and the second time t₂ in the past and the virtual third time t₃ not included therein, to the user 50 as the scenario map.

At Step 213, if it is necessary for the user 50 to change the network graph display condition 26, the process returns to Step 211, or if not necessary it proceeds to Step 214.

At Step 214, if the user is satisfied with the presented result of the network-graph display result 27, namely the scenario map, as a choice for the decision-making, the process proceeds to the next Step 215 to be terminated, or if the user is not satisfied, the process returns to Step 202 to perform the network graph generation (first to third graph generations) again.

In this manner, she first network graph at the first time from the past to the present and the second network graph at the second time different from the first time are generated based on the acquired data and the generation condition, and furthermore, based on the first network, graph and the second network graph, the simulation corresponding to the generation condition is executed to generate the third network graph at the virtual third time.

An exemplary display screen 60 in FIG. 2B shows an example of the network graph display 27 at Step 212 in FIG. 2A. In this example, the display screen 60 has three screens 61 corresponding to the first time t₁ in the past, the second time t₂ at or close to the present, and the third time t₃ in the future (or optional past), and each of the screens 61 comprises a time slider 62 and a network-graph display unit 63.

At Step 211, when the user specifies a time (black portion) on the time slider 62 via the terminal 50, the network graph generation results (first to third graph generation results) 15₀-15n corresponding to the time are extracted and the network graph display 27 is executed at Step 212.

In the exemplary display screen 60, regarding the given context, the left screen displays a network graph 71 (first graph generation result) at the first time t₁ in the past specified by the time slider 62, the center screen displays a network graph 72 (second graph generation result) at the second time t₂ specified by the time slider 62, and the right screen displays a network graph 73 (third graph generation result) at the third time t₃ specified by the time slider 62.

The network-graph display unit 27 outputs and displays the network graph generated result on the display screen 60 of the display 29. The network graphs 71-73 on the exemplary display screen 60 in FIG. 2B, namely the scenario maps, assume each of the extracted texts as a vertex and indicate a magnitude correlation of the frequency of the text, data among them by the size of the vertices and a magnitude correlation of the co-occurrence degree among the text data by the thickness of the edges, where the network graphs 71-73 change as the time passes by from the past t₁ to the present t₂, and to the future t₃. It should be noted that, although the display screen 60 also displays names of the text, data corresponding to respective vertices, the display thereof is omitted in FIG. 2B.

According to the network graph generation method described in the first embodiment, by the decision-making support system 1 presenting the new network graph 73 at the virtual time (third time t₃) along with the network graphs 71, 72 at the first time t₃ from the past to the present and the second time t₂ on the terminal 50 of the user as the scenario map for the given context, there can be an increased range of choices for the decision-making for the uncertain future restricted by the bounded rationality and improved effect of supporting the user's concern and understanding. That is, by creating the various network graphs or scenario maps at the virtual time (third time) and presenting them to the user, there is an effect of supporting the satisfactory decision-making for the uncertain future.

Although the network graphs 71-73, namely the scenario maps, are generated with the data frequency depicted as the vertex and the co-occurrence degree as the edge in the first embodiment, they may be depicted as a potential map or a mind map.

Although the decision-making support system 1 includes the distributed processing platforms 17₀-17ₙ to use the big data, the simulation programs 16₀-16ₙ operating thereon need to generate the network graph constituted by a huge amount of vertices and edges, and therefore a multi-agent simulation and an asynchronous parallel computation with an actor model are suitable. Moreover, although the client-server system is constituted to have the client 20 serve as a user interface and hove the servers 10₀-10n perform a computation for the network graph generation, it is also possible to have multiple clients perform a distributed processing and the invention is not limited to the system configuration described in the first embodiment.

The first embodiment can achieve the decision-making support system allowing for an interactive cooperation between a human and a computer using the big data by introducing the client-server system.

Moreover, by introducing the time slider 62 as a method of the network-graph display condition input 26, it is possible to continuously comprehend the transition of the network graphs 71-73 spanning from the past to the present and then to the future, thereby deepening an insight for the future. By presenting the scenario maps panoramically or locally changing not only the time but also the time range (time period) with the time slider 62 or by displaying the scenario maps as a movie by automatically forwarding the time, new concern can be more easily induced in the decision-making. That is, by presenting the various scenario maps as alternative choices using the big data, the degree of freedom for the decision-making is increased and more opportunities for the chance discovery can be provided, and displaying the scenario maps according to the time slider or the choices supports the concern and the understanding of the human that is the decision-making entity.

### Second Embodiment

As a second embodiment, an example is given that is more concrete than the first embodiment using text data as an object of the “context,” thereby showing a method of developing a network graph into the future. FIG. 3 is a flowchart illustrating a network graph generation method according to the second embodiment. FIGS. 4A-4H are diagrams showing examples of the display screen of the client 20. The configuration of the hardware or the decision-making support system to achieve the second embodiment may be the same as that of the decision-making support system according to the first embodiment shown in FIG. 1. For simplicity, the description of the system configuration is omitted.

A flowchart 300 starts from Step 301 of inputting a condition setting. FIG. 4A shows a screen 401 of a display 400 for a new search, and includes input boxes 402-406 and a search start button 407 displayed thereon. By entering a text data acquisition condition in the input box 402 and further entering a start date 403, an end date 404, a step count 405, a maximum screen count 406 and the like and pressing the start button 407, the data acquisition, the simulation, and the network graph generation are executed according to the default setting. In this example, a search word “big data” is entered in the input box 402 as the text data acquisition condition. It is noted that the step count 405 indicates a unit period of the search processing or the simulation such as every six months, and the maximum screen count 406 indicates the maximum count of the screens to be output.

At Step 302 in FIG. 3, the text data is acquired by the search engine based on the set search word, and at Step 303, the frequency end the co-occurrence degree of a word that constitutes the text data are calculated by the morphological analysis. Thus, the network graph generation data (first and second graph generation data; from the past to the present can be obtained.

After Step 303, the process diverges into four simulations of growth, derivation, alternation, and disturbance depending on the condition of the future scenario set by the user.

At Step 304 (growth) of the future scenario, the frequency and the co-occurrence degree for toe future are estimated by simulation based on the time-series analysis of the frequency and the co-occurrence degree from the past to the present (Step 305), and the simulation is repeated until the termination condition is satisfied. When the termination condition is satisfied (YES at Step 306), the network graph of the context scenario map from the past to the future (third graph=growth) is generated (Step 307), the network graph is displayed according to the display condition (Step 308), arid the process proceeds to Step 309 to be terminated. The prediction technique based on the simulation may be selected from the regression analysis method, the moving-average method, the exponential, smoothing method, and the like, and the periodicity and the causal effect may be taken into account.

At Step 310 (derivation), a word with a high frequency or a high co-occurrence degree is added to search words for a re-search (Step 314), the frequency and the co-occurrence degree as a result of the re-search are calculated by the morphological analysis (Step 315), and the process returns to Step 314 depending on the simulation condition to repeat the re-search. When the simulation is terminated (YES at Step 316), the network graph taking the repetition of the re-search as a time evolution for the future (third graph-derivation) is generated (Step 317), the graph is displayed (Step 313), and the process is terminated at Step 309.

At Step 320 (alternation), the re-search is performed using a co-occurring pair of words (Step 324), the two words constituting the co-occurring pair are alternated with a highly co-occurring word other than the words(Step 325), and the process returns to Step 324 according to the simulation condition to repeat the research. When the simulation is terminated (YES at Step 326), the network graph using the repetition of the alternation at Step 321 as the time evolution for the future (third graph=alternation) is generated (Step 327), the graph is displayed (Step 328), and the process is terminated at Step 309.

At Step 330 (disturbance), the frequency of the word, is accumulated randomly or stochastically (Step 334). If the frequency of the word exceeds a threshold according to a predetermined rule, the frequency is distributed to its co-occurring word depending on the co-occurrence degree (Step 335), and the process returns to Step 334 according to the simulation condition to repeat the accumulation. Although this method follows the sandpile avalanche model in complex systems, the earthquake model or the like may be otherwise used. When the simulation is terminated (YES at Step 336), the network graph using the repetition of the accumulation as the time evolution for the future is generated (Step 337), the graph (third graph=disturbance) is displayed (Step 338), and the process is terminated at Step 309.

FIGS. 4B-4H indicate situations of the network graphs (first, second graphs) generation data from the past to the present and the network graph (third graph=growth) generation data for the future based thereon that are displayed on the display 400. In each drawing, the thickness of the line between letters indicates the co-occurrence degree with the search word “big data”, and the size of the letter itself indicates the frequency. Moreover, the line is omitted for those having a low co-occurrence degree. The delimitation between the periods of the first and second graphs suffices to be suitable for the following simulation. For convenience, an explanation is given herein assuming FIGS. 48 and 4C as the first graph generation data and FIGS. 4D and 4E as the second graph generation data.

A network graph 420 at the step shown in FIG. 4B (April 2009-September 2009) is based on a data analysis 411 regarding “big data”.

In the network graph 420 at the step shown in FIG. 4C (April 2010-September 2010), it can be seen from the thickness of she letters and the thickness of the lines that use of the “big data” in an enterprise 421 has started. In a network graph 430 at the step shown in FIG. 4D (April 2011-September 2011), based on the thickness of the letters and the thickness of the lines, the “big data” has started to spread out (431), and the cloud and Hadoop (registered trademark) are visible. In a network graph 440 at the step in FIG. 4E (October 2011-March 2012), the “big data” has spread at once and the use thereof for a business strategy 441 has also started.

Next, FIGS. 4F-4H snow the process of generating the network graph of the scenario map at the time from the present to the future (third graph=growth) by the simulation based on the “growth” in the future scenario, in a network graph 450 at the step in FIG. 4F (October 2012-March 2013), it can be seen that a vendor 451 and a platform 152 for the “big data” have starred to spread out. In a network graph 460 at the step in FIG. 4G (October 2013-March 2014), a social medium 462 appears in addition to a sensor and Google (registered trademark) 461. In a network graph 470 at the step in FIG. 4H (October 2014-March 2015), the use of a social medium 471 has also been developed.

According to the second embodiment, by creating various network graphs or scenario maps at new time points, there is an effect of performing more satisfactory decision-making for the uncertain future. Moreover, by presenting various scenario maps as alternative choices, the degree of freedom for the decision-making is increased and more opportunities for the chance discovery can be provided, and displaying the scenario maps according to the time slider or the choices supports the concern and the understanding of the human that is the decision-making entity. Furthermore, the decision-making support system can be achieved that allows for the interactive cooperation between a human and a computer using the big data.

Especially according to the network graph generation method for the future scenario shown in the second embodiment, based on the scenario maps from the past to the present, by historically developing the data along the trend or the periodicity at Steps 304-308 (growth), systematically differentiating the data at Steps 310-318 (derivation), genetically alternating generations at Steps 320-328 (alternation), and causing the natural selection at Steps 330-338 (disturbance), it is possible to present various scenario maps that may occur in the future as network graphs (growth, derivation, alternation, disturbance), which are useful for the decision-making support service and context-aware service.

Although the network graphs are generated based on the analogy of ecosystem in the second embodiment, another approach such as a pattern language or a game theory may be introduced to the network graph generation. Moreover, although the explanation is given taking an example of the text data as the object of the “context,” the graph generation method according to the second embodiment or based on a similar simulation can be extended to other time-series data of stock prices, distribution, traffic, earthquakes, and the like, design pattern data of a city, a building, software, and the like, and network data of a social medium, a community, an enterprise organization, and the like.

### Third Embodiment

A third embodiment of the present invention describes another example of a display screen of a network graph 500 generated by the processing according to the first and second embodiments and displayed by the display 29. FIG. 5 is a time-series transition diagram, of the network graph according to the third embodiment, which is a schematic diagram showing the display screens of the network graph 500 arranged in time series along a time axis 501 from the past to the present and then to the future.

Network graphs 510 are multiple first graphs generated based on the history data from the past to the present, network graphs 511 are multiple second graphs generated based on the history data from the past to the present, and network graphs 521-524 are multiple future scenario graphs (third graphs) generated based on the history data or the network graphs 510, 511, which are diverged variedly depending on the possibilities that may occur in the future.

Multiple network graphs 512, 513 are the graphs (third graphs) of the past that could have occurred, which are generated based on the multiple history data 510, 511 from the past to the present or going back from the present situation, and network graphs 531-533 are the graphs (third graphs) spanning from the past that could have occurred to the future that can possibly occur, which are generated based on the third graphs 512, 513.

Although the time axis 501 in the third, embodiment indicates the flow of the time from the past to the future and the network graphs 510, 511 are displayed along the time axis 501 of the absolute time, the network graphs 512, 513, 521-524, 531-533 may be displayed along the time axis 501 of the absolute time or the relative time depending on the graph generation method.

The third embodiment provides the similar effects to the first and second embodiments.

Especially, according so the third embodiment, by generating the network graphs 510-513, 521-524, 531-533 according to the data acquisition condition and the simulation condition and displaying them on the screen of the display 29 according to the graph display condition, it is possible to visualize various future scenarios to contribute to the chance discovery and the decision-making.

### Fourth Embodiment

A fourth embodiment of the present invention describes another example of the display screen of the network graph displayed on the display 29 of the client in the first embodiment. FIGS. 6A and 6B are display screen shots for explaining the network graph generation method according to the fourth embodiment, and show exemplary screens to be displayed on a display 601 of a client terminal 600 taking the text data as an example.

Displayed on the display 601 in FIG. 6A are a system appellation 610, an input box 611, a start button 612, and a menu bar 620. “Kairos” in the appellation 610 is the name of the Greek deity of chances, which is suitable for the system presenting the future scenario since the chance is a significant turning point of an event series (scenario) in decision-making. When a search word is entered to the input box 611 as the text data acquisition condition and the start button 612 is pressed, the data acquisition, the simulation, and the network graph generation are executed according to the default setting.

To change the default setting, it suffices to select an option from the menu bar 620. A start date (year-month-day), an end date (year-month-day), and an interval date (year-month-day) are input to a pull-up menu 621 for the search condition, checkboxes of unification of the letter type, unification of the synonyms, an unnecessary word filter, and a user specification are selected as a processing of the searched text data in a pull-up menu 622 for the processing condition, and checkboxes of the growth, the derivation, the alternation, the disturbance, and the user specification are selected as the simulation condition in a pull-up menu 623 for the future scenario.

Displayed on a network-graph display unit 630 of the display 601 in FIG. 6B is a network graph (third graph; 631 according to the graph display conditions on a time slider 640, action buttons 641, a future scenario selection unit 642. The network graph 631 is a scenario map indicating the texts (abbreviated by A-J for simplicity) by vertices, their frequencies by the size of the vertices, the co-occurrence relation between the texts by edges, and their co-occurrence degree by the thickness of the edges.

The network graph 631 is displayed according to the specification of the time from the past to the present and to the future by the time slider 640, according to the specification of the playback, step forward, fast forward, reverse playback, step backward, rewind, stop, or pause by the action buttons 641, and according to the checkboxes of the growth, derivation, alternation, disturbance, and user specification selected by the future scenario selection unit 642.

The fourth embodiment also provides the similar effects to the first to third embodiments.

Especially, by interactively entering the data acquisition condition, the simulation condition, and the graph display condition from the client terminal 600 through tire display 601 as described in the fourth embodiment and thereby associating the search in the scenario map with the decision-making with the client or the human and the computer cooperating with each other, it is possible to achieve the autopoiesis system developing into the future.

Although a graphic user interface of a tablet terminal or a mobile terminal is assumed as the client terminal 600 described in the fourth embodiment, other human-computer interaction may be used such as a nonverbal interface based on audio and gestures, a multi-user interface for cooperative activities, and a virtual reality interface.

### REFERENCE SIGNS LIST

1 Decision-making support system
10₀-10ₙ Server
11₀-11ₙ Processor
12₀-12ₙ Memory
13₀-13ₙ Program
14₀-14ₙ Data acquisition program
15₀-15ₙ Network graph generation program
16₀-16ₙ Simulation program
17₀-17ₙ Distributed processing platform
18₀-18ₙ Network interface
20 Client
21 Processor
22 Memory
23 Program
24 Data acquisition condition input
25 Simulation condition input
26 Network-graph display condition input
27 Network graph display
28 Network interlace
29 Display
30 Network
40 Database
50 User terminal
60 Exemplary display screen
61 Screen
62 Time slider
63 Network-graph display unit
71-73 Network graph
200 Flowchart
S201-S215 Steps
300 Flowchart
S301-S338 Steps
500 Network graph
501 Time axis
510 Network graph iron; the past to the present (first graph)
511 Network graph from the past to the present (second graph)
512, 513 Network graphs of the past that could have occurred
521-524 Future network graphs (third graphs) based on the history from the past to the present
531-533 Future network graphs (third graphs) based on the past that could have occurred
600 Client terminal
601 Display
610 System appellation
611 Input box
620 Menu bar
621-623 Pull-up menus
630 Network-graph display unit
631 Network graph
640 Time slider
641 Action button
642 Future scenario selection unit

1. A network graph generation method using a decision-making support system,
wherein the decision-making support system comprises a condition input reception function, a data acquisition function, a graph generation function, a simulation function, and a database,
the method comprising steps of:
receiving an input of a network graph generation condition;
acquiring data about a certain context based on the generation condition input thereto and accumulates the data in the database;
generating a first network graph at a first time from the past to the present corresponding to the generation condition based on the acquired data about the certain context;
generating a second network graph at a second time from the past to the present that differs from the first time corresponding to the generation condition based on the acquired data about the certain context; and
generating a third network graph at a virtual third time based on the first network graph and the second network graph by simulation corresponding to the generation condition.

2. The network graph generation method according to claim 1,
wherein the third network graph is generated by growing, deriving, alternating, or disturbing the first network graph and the second network graph by the simulation.

3. The network graph generation method according to claim 1,
wherein the decision-making support system includes multiple types of simulation functions based on different prediction methods,
the third time is in the future, and
one of the third network graphs generated by the simulation is a network graph generated by developing the first network graph and the second network graph into the future.

4. The network graph generation method according to claim 1,
wherein the decision-making support system includes multiple types of simulation functions based on the different prediction methods, and
one of the third network graphs generated by the simulation is a network graph generated based on the difference between the first network graph and she second network graph.

5. The network graph generation method according to claim 1,
wherein each of the first network graph, the second network graph, and the third network graph is a scenario map presenting a frequency as a vertex and a co-occurrence degree as an edge.

6. The network graph generation method according to claim 1,
wherein the decision-making support system includes a display screen;
the method further comprising steps of:
receiving an input of a display condition of each of the network graphs; and
displaying the first, second, or third network graph on the display screen based on the display condition.

7. A network graph generation method using a decision-making support system,
wherein the decision-making support system includes a condition input reception function, a data acquisition function, a graph generation function, multiple types of simulation functions based on different prediction methods, and a database,
the method comprising:
a first step of receiving an input of a network graph generation condition;
a second step of acquiring data about a certain context from the past to the present based on the generation condition input thereto;
a third step of generating a first network graph at a first, time from the past to the present and a second network graph at a second time different from the first time based on the acquired data and the generation condition; and
a fourth step of performing a simulation according to any one of the simulation functions corresponding to the generation condition based on the first network graph sad the second network, graph and generating a third network graph at a virtual third time different from the first time and the second time.

8. The network graph generation method according to claim 7, wherein, the fourth step includes:
generating the third network graph by growing, deriving, alternating, or disturbing the first network graph and the second network graph by the simulation.

9. The network graph generation method according to claim 7,
wherein the decision-making support system includes a display screen,
the third time is in the future,
the first step includes receiving an input of a display condition of each of the network graphs, and
the fourth step includes generating the third network graph by developing the first network graph and the second network graph into the future by the simulation; and
the method further comprising:
a fifth step of displaying the first, second, or third network graph on the display screen according to the specified time of one time slider based on the display condition.

10. The network graph generation method according to claim 7,
wherein the third network graph is displayed according to a selection of the simulation function.

11. The network graph generation method according to claim 7,
wherein the decision-making support system is a client-server system including a server, a client, and a network,
the server includes a data acquisition function, a graph generation function, and a simulation function, and
the method comprising:
the first step of inputting the network graph generation condition including a data acquisition condition and a simulation condition from the client;
the second step of the server acquiring data from the past to the present;
the third step of the server generating the first network graph at the first time from the past to the present and the second network graph at a second time based on the acquired data;
the fourth step of the server generating the third network graph at the virtual third time by a simulation based on the acquired data; and
a fifth step of displaying the first to third network graphs on the client.

12. The network graph generation method according to claim 11,
wherein the network graph generation condition and a network-graph display condition are interactively input from the client.

13. A decision-making support system comprising a client-server system including a server, a client, a network, and a database,
wherein the client includes:
a condition input reception function of receiving a generation condition of a network graph; and
a display screen;
wherein the server includes:
a data acquisition function of acquiring data about a certain context based or the generation condition input thereto and accumulating the data in the database;
a graph generation function of generating the network graph; and
multiple types of simulation functions based on different prediction methods,
wherein the decision-making support system comprising steps of:
generating a first network graph at a first time from the past to the present corresponding to the generation condition based on the acquired data about the certain context;
generating a second network graph at a second time from the past to the present that is different from the given first time corresponding to the generation condition based on the acquired data about the certain context;
generating a third network graph at a virtual third time by performing the simulation function corresponding to the generation, condition based on the first network graph and the second network graph; and
displaying the first, second, or third network graph on the display screen.

14. The decision-making support system according to claim 13,
wherein the server generates multiple sheets of the third network graphs by growing, deriving, alternating, or disturbing the first network graph and the second network graph, by multiple types of simulations corresponding to the generation condition.

15. The decision-making support system according to claim 13,
wherein the network graph generation condition and the network-graph display condition are interactively input from the client.
